(19) United States
(12) Patent Application Publication
(10) Pub. No.: US 2017/0300982 A1
(43) Pub. Date: Oct. 19, 2017

(54) Thrive! System

(71) Applicant: Gary A. Christopherson, Nelson, WI (US)

(72) Inventor: Gary A. Christopherson, Nelson, WI (US)

(21) Appl. No.: 15/243,307

(22) Filed: Aug. 22, 2016

(51) Int. Cl. G06Q 30/06; G06N 99/00

(52) U.S. Cl. CPC G06Q 30/0601; G06N 99/005

(57) ABSTRACT

Thrive! system is a process that helps provide everything, using Internet and what it accesses and connects together, that a person, persons and world want and need to survive and thrive. Everything for a person, a person's family and friends, a community and the world. It is an “all people and world” approach, an “all survive and thrive” approach for all people and world, and an “all forever” approach for all people and world. The Thrive! system helps to think, integrate and go beyond combined usability, capability and value of Google, Facebook, Twitter, Siri, Cortana, Watson, YouTube, Snapchat, Booking, Pinterest, Amazon, Angie's List, HomeAdvisor, Wikipedia, LinkedIn, etc.

### BACKGROUND OF THE INVENTION

### 1. Field of the Invention

The present invention, the Thrive! System, is directed to a computer-human interface for quickly and easily retrieving desired information, tools and support via a computer or human system. More specifically, the present invention is directed to a universal interface to help meet needs in real time using multiple heuristic algorithms integrated into a system to bring to bear all available information and resources from anywhere in real time and to use all available human and non-human capability, information, tools and support systems from anywhere in real time. The system supports person and persons in micro-moments and macro-moments when needing to think, obtain information, learn, develop, buy, sell, connect, seek positive, avoid negative, feel better, go, fix, see, hear, smell, touch, taste, communicate, create, solve, build and/or achieve. In support of the person or persons, the system integrates all information, capability and resources into a customized Thrive! support system in real time.

### 2. Description of the Related Art

One of the needs of and opportunities for a person or persons, with the recent growth in the tools available and in the amount of data and information available via networks and the Internet, is to be able to simultaneously access the full range of available tools and information and to fully integrate these tools and this information into a system that fully supports a person or persons achieving surviving and thriving.

To satisfy parts of this need, many tools provide part of the information, tools and support a person or persons needing to survive and thrive. Examples of such tools include Google, Facebook, Twitter, Siri, Watson, YouTube, Snapchat, Booking, Pinterest, Amazon, Wikipedia, LinkedIn, Angie's List, and HomeAdvisor. While useful, these tools individually and together fail in real time to fully meet the needs of a person or persons trying to survive and thrive.

### SUMMARY OF THE INVENTION

The present invention, the Thrive! System, is for everything [using Internet and what it accesses and connects together] that a person or person wants and needs to survive and thrive. Everything for a person, a person's family and friends, a community and the world. It helps during micro-moments and macro-moments. It helps a person or persons get what is needed. It helps a person or persons do what is needed. It helps a person or persons in a way that understands and respects that the future is about all (a person, all people and our world), about surviving and thriving, and about tomorrow and the long term future. A true “all people and world” approach. A true “all survive and thrive” approach for all people and world. A true “all forever” approach for all people and world.

The present invention, the Thrive! System, provides Google-like searches but goes further by seamlessly providing and integrating all information and functions in real-time. It provides a personal assistant like Siri but goes further in scope and depth as a person and multiple person assistant, and goes further using internet bots to run automated tasks. It provides intelligence, analytic and processing capability like Watson but goes further by being more publicly accessible and integrating with other Thrive! information and functions. It gets things like Amazon and services like Angie's List and HomeAdvisor but gets whatever is needed from any source at optimal quality, cost and time. It uses best human, animal, plant, mineral and machine capability. It does what needs to be done to survive and thrive - perform well, be well-off (financially), be well nourished, be well housed, be well protected (exposures, crime), be well educated, be physically and mentally well (people), grow/develop well, live within good habitat, be physically well (Earth, plants, animals, environment), not be vulnerable, produce personal and public goods, live within a stable, positive climate, and be sustained. It builds upon, greatly enhances and integrates all of these for surviving and thriving.

The present invention, the Thrive! System, supports an individual person, a community (groups, geographic areas, towns and cities, states, countries) and the world. It supports person and multiple persons in micro-moments and macro-moments when needing to think, obtain information, learn, develop, buy, sell, connect, seek positive, avoid negative, feel better, go, fix, see, hear, smell, touch, taste, communicate, create, solve, build and/or achieve. It supports a surviving and thriving future. It aspires to a future when all thrive forever.

During a micro-moment or macro-moment, a person or persons may need to do or get something, the present invention, the Thrive! System, can help make it happen in real time. A person or persons tells it—“I need . . . . ” and, as needed, sets any preferred rules for Thrive! System. It brings to bear every available resource from anywhere to help make it happen in real time. It brings to bear all available human and non-human capability, information, tools and support systems from anywhere in real time. It integrates all into a customized support system in real time. It uses all Internet-capable devices. It eliminates jumping from website to website or app to app for help. It addresses both near and long term need. It addresses need in context of your and all others' needs. It suggests other needs that might be appropriate. It suggests what will help a person, persons and the world survive and thrive.

The invention is not limited to only the embodiments set forth within this disclosure. Rather, the system and its elements described herein are meant to be exemplary of many elements that can be employed, for the purpose of helping a person or persons survive and thrive.

In addition to the features mentioned above, objects and advantages of the present invention will be readily apparent upon a reading of the following description.

### BRIEF DESCRIPTION OF THE DRAWINGS

Novel features and advantages of the invention become apparent reading the following detailed description in conjunction with the accompanying drawing which illustrates a depiction of the Thrive! system that helps provide everything, using Internet and what it accesses and connects together, that a person, persons and world want and need to survive and thrive.

### DETAILED DESCRIPTION OF THE INVENTION

The preferred system herein described is not intended to be exhaustive or to limit the invention to the precise embodiments disclosed. The preferred system is described to explain the principles of the invention and its application.

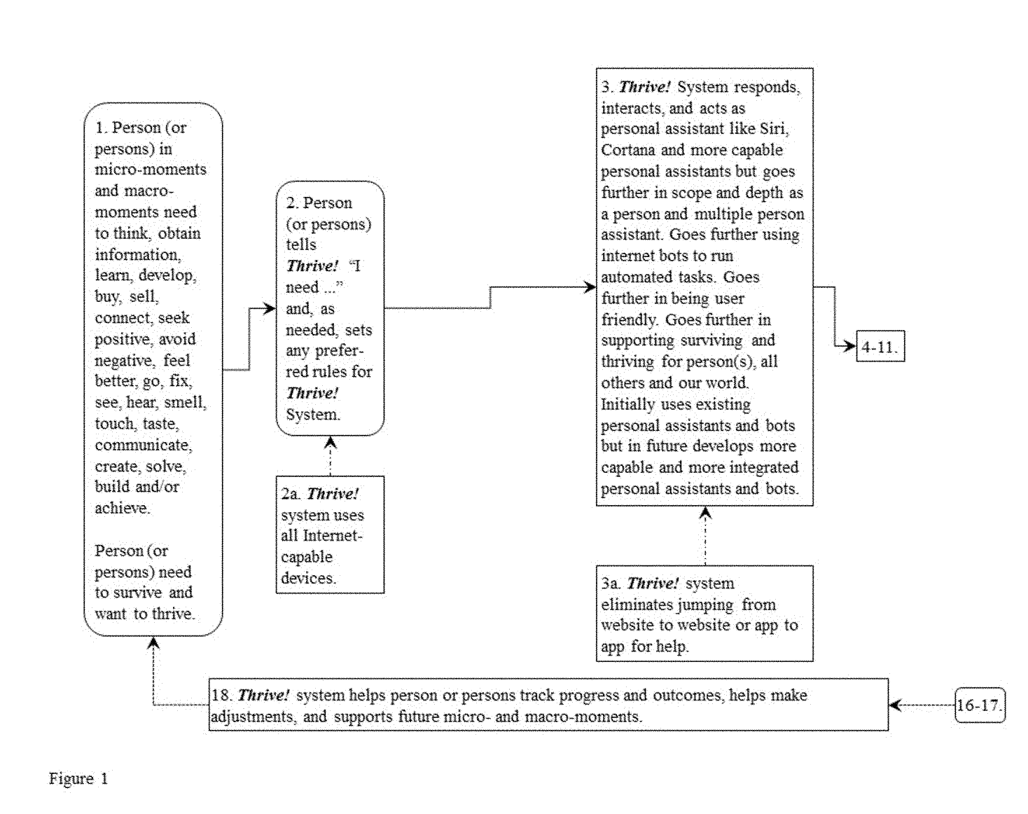

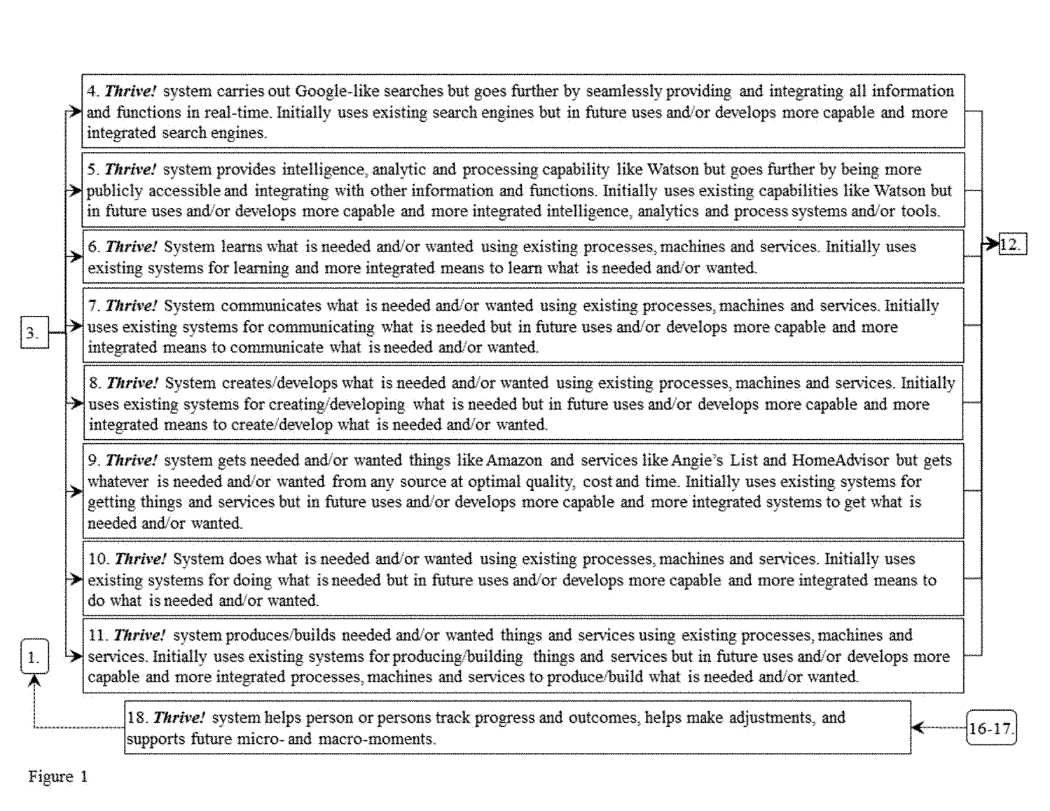

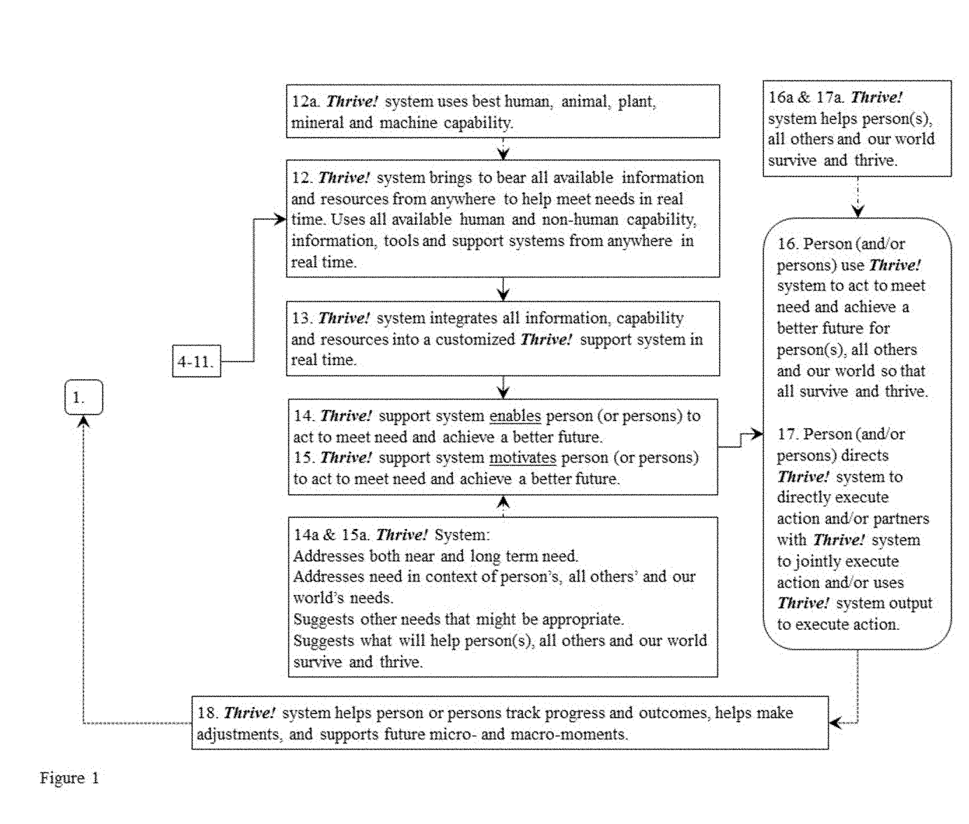

FIG. 1 illustrates the illustrates the Thrive! system that helps provide everything, using Internet and what it accesses and connects together, that a person, persons and world want and need to survive and thrive.

The Thrive! System:

1. Person or persons in micro-moments and macro-moments need to think, obtain information, learn, develop, buy, sell, connect, seek positive, avoid negative, feel better, go, fix, see, hear, smell, touch, taste, communicate, create, solve, build and/or achieve.

2. Person (or persons) tells Thrive! “I need . . . ” and, as needed, sets any preferred rules for Thrive! System.

a. Thrive! system uses all Internet-capable devices.

3. Thrive! System responds, interacts, and acts as personal assistant like Siri, Cortana and more capable personal assistants but goes further in scope and depth as a person and multiple person assistant. Goes further using internet bots to run automated tasks. Goes further in being user friendly. Goes further in supporting surviving and thriving for person(s), all others and our world. Initially uses existing personal assistants and bots but in future develops more capable and more integrated personal assistants and bots.

4. Is conversational. Interacts to incorporate person or persons wants and needs. Incorporates person or persons need to survive and desire to thrive. Incorporates need and desire for a better future for person(s), all others and our world so that all survive and thrive. Incorporates artificial intelligence. Initially uses existing personal assistants but in future develops more capable, more positive value driven, and more integrated personal assistants.

a. Thrive! system eliminates jumping from website to website or app to app for help.

5. Thrive! System carries out Google-like searches but goes further by seamlessly providing and integrating all information and functions in real-time. Initially uses existing search engines but in future uses and/or develops more capable and more integrated search engines.

6. Thrive! System provides intelligence, analytic and processing capability like Watson but goes further by being more publicly accessible and integrating with other information and functions. Initially uses existing capabilities like Watson but in future uses and/or develops more capable and more integrated intelligence, analytics and process systems and/or tools.

7. Thrive! System learns what is needed and/or wanted using existing processes, machines and services. Initially uses existing systems for learning and more integrated means to learn what is needed and/or wanted.

8. Thrive! System communicates what is needed and/or wanted using existing processes, machines and services. Initially uses existing systems for communicating what is needed but in future uses and/or develops more capable and more integrated means to communicate what is needed and/or wanted.

9. Thrive! System creates/develops what is needed and/or wanted using existing processes, machines and services. Initially uses existing systems for creating/developing what is needed but in future uses and/or develops more capable and more integrated means to create/develop what is needed and/or wanted.

10. Thrive! System gets needed and/or wanted things like Amazon and services like Angie's List and

HomeAdvisor but gets whatever is needed and/or wanted from any source at optimal quality, cost and time. Initially uses existing systems for getting things and services but in future uses and/or develops more capable and more integrated systems to get what is needed and/or wanted.

11. Thrive! System does what is needed and/or wanted using existing processes, machines and services. Initially uses existing systems for doing what is needed but in future uses and/or develops more capable and more integrated means to do what is needed and/or wanted.

12. Thrive! System produces/builds needed and/or wanted things and services using existing processes, machines and services. Initially uses existing systems for producing/building things and services but in future uses and/or develops more capable and more integrated processes, machines and services to produce/build what is needed and/or wanted.

13. Thrive! system brings to bear all available information and resources from anywhere to help meet needs in real time. Uses all available human and non-human capability, information, tools and support systems from anywhere in real time.

a. Thrive! system uses best human, animal, plant, mineral and machine capability.

14. Thrive! system integrates all information, capability and resources into a customized Thrive!

support system in real time.

15. Thrive! support system enables person (or persons) to act to meet need and achieve a better future.

a. Addresses both near and long term need.

b. Addresses need in context of person's, all others' and our world's needs.

c. Suggests other needs that might be appropriate.

d. Suggests what will help person(s), all others and our world survive and thrive.

16. Thrive! support system motivates person (or persons) to act to meet need and achieve a better future.

a. Addresses both near and long term need.

b. Addresses need in context of person's, all others' and our world's needs.

c. Suggests other needs that might be appropriate.

d. Suggests what will help person(s), all others and our world survive and thrive.

17. Person (and/or persons) use Thrive! system to act to meet need and achieve a better future for person(s), all others and our world so that all survive and thrive. System shepherds actions to prevent harm to person(s), all others and our world. System shepherds actions to support near and long term surviving and thriving for person(s), all others and our world.

a. Thrive! system helps person(s), all others and our world survive and thrive.

18. Person (and/or persons) directs Thrive! system to directly execute action and/or partners with

Thrive! system to jointly execute action and/or uses Thrive! system output to execute action.

19. Thrive! system helps person or persons track progress and outcomes toward surviving and thriving, helps make adjustments, and supports future micro- and macro-moments that contribute toward surviving and thriving for person(s), all others and our world.

Many of the elements indicated above may be altered or replaced by different elements which will provide the same or better result and will fall within the spirit of the claimed invention. It is the intention, therefore, to limit the invention only as indicated by the scope of the claims.

What is claimed is:

1. Thrive! system is a process that helps provide everything [using Internet and what it accesses and connects together] a person, persons and world want and need to survive and thrive. Everything for a person, a person's family and friends, a community and the world. It is an “all people and world” approach, an “all survive and thrive” approach for all people and world, and an “all forever” approach for all people and world. [Trademarks owned by Gary A. Christopherson include Thrive!®, Thrive! Endeavor®, All Thrive Forever®, T!®, What will you do?®, and HealthePeople O.]

2. The process in claim 1, wherein the system helps during micro-moments and macro-moments. Micro-moments occur “when people reflexively turn to a device—increasingly a smartphone—to act on a need to learn something, do something, discover something, watch something, or buy something”. [Source: Google, 2016.] Macro-moments occur “when people turn to best resource(s) to act on complex need(s) to learn something, do something, discover something, watch something, produce something and/or buy something in real-time”. [Source: Christopherson, 2016.]

3. The process in claim 1, wherein person (or persons) tells Thrive! “I need . . . ” and, as needed, sets any preferred rules for Thrive! System and the system accepts what the person (person) tells the system.

4. The process in claim 1, wherein the system helps a person and persons get what is needed.

5. The process in claim 1, wherein the system helps a person and persons do what is needed.

6. The process in claim 1, wherein the system helps a person and persons in a way that understands and respects that the future is about all (a person, all people and our world), about surviving and thriving, and about tomorrow and the long term future.

7. The process in claim 1, wherein the system helps a person, all persons and our world survive and thrive.

8. Thrive! system utilizes the full range of other processes to achieve what a person, persons and world want and need to survive and thrive.

9. The process in claim 8, wherein the system responds, interacts, and acts as personal assistant like Siri Cortana and more capable personal assistants but goes further in scope and depth as a person and multiple person assistant. Goes further using internet bots to run automated tasks. Goes further in being user friendly. Goes further in supporting surviving and thriving for person(s), all others and our world. Initially uses existing personal assistants and bots but in future develops more capable and more integrated personal assistants and bots.

10. The process in claim 8, wherein the system carries out Google-like searches but goes further by seamlessly providing and integrating all information and functions in real-time. Initially uses existing search engines but in future uses and/or develops more capable and more integrated search engines.

11. The process in claim 8, wherein the system provides intelligence, analytic and processing capability like Watson but goes further by being more publicly accessible and integrating with other information and functions. Initially uses existing capabilities like Watson but in future uses and/or develops more capable and more integrated intelligence, analytics and process systems and/or tools.

12. The process in claim 8, wherein the system learns what is needed and/or wanted using existing processes, machines and services. Initially uses existing systems for learning and more integrated means to learn what is needed and/or wanted.

13. The process in claim 8, wherein the system communicates what is needed and/or wanted using existing processes, machines and services. Initially uses existing systems for communicating what is needed but in future uses and/or develops more capable and more integrated means to communicate what is needed and/or wanted.

14. The process in claim 8, wherein the system creates/develops what is needed and/or wanted using existing processes, machines and services. Initially uses existing systems for creating/developing what is needed but in future uses and/or develops more capable and more integrated means to create/develop what is needed and/or wanted.

15. The process in claim 8, wherein the system gets needed and/or wanted things like Amazon and services like Angie's List and HomeAdvisor but gets whatever is needed and/or wanted from any source at optimal quality, cost and time. Initially uses existing systems for getting things and services but in future uses and/or develops more capable and more integrated systems to get what is needed and/or wanted.

16. The process in claim 8, wherein the system does what is needed and/or wanted using existing processes, machines and services. Initially uses existing systems for doing what is needed but in future uses and/or develops more capable and more integrated means to do what is needed and/or wanted.

17. The process in claim 8, wherein the system produces/builds needed and/or wanted things and services using existing processes, machines and services. Initially uses existing systems for producing/building things and services but in future uses and/or develops more capable and more integrated processes, machines and services to produce/build what is needed and/or wanted.

18. Thrive! system is a process that brings to bear all available information and resources from anywhere to help meet needs in real time. Uses all available human and non-human capability, information, tools and support systems from anywhere in real time.

19. The process in claim 18, wherein the system integrates all information, capability and resources into a customized Thrive! support system in real time.

20. The process in claim 18, wherein the system uses best human, animal, plant, mineral and machine capability.

21. The process in claim 18, wherein the system thinks, integrates and goes beyond combined usability, capability and value of Google, Facebook, Twitter, Siri, Watson, YouTube, Snapchat, Booking, Pinterest, Amazon, Wikipedia, LinkedIn, Angie's List, HomeAdvisor, etc.

22. Thrive! system builds upon, greatly enhances and integrates all of the above for surviving and thriving.

23. Thrive! system supports an individual person, a community (groups, geographic areas, towns and cities, states, countries) and our world.

24. The process in claim 23, wherein the system helps do what needs to be done to survive and thrive - perform well, be well-off (financially), be well nourished, be well housed, be well protected (exposures, crime), be well educated, be physically and mentally well (people), grow/develop well, live within good habitat, be physically well (Earth, plants, animals, environment), not be vulnerable, produce personal and public goods, live within a stable, positive climate, and be sustained.

25. The process in claim 23, wherein the system supports person and multiple persons in micro-moments and macro-moments when needing to think, obtain information, learn, develop, buy, sell, connect, seek positive, avoid negative, feel better, go, fix, see, hear, smell, touch, taste, communicate, create, solve, build and/or achieve.

26. The process in claim 23, wherein the system, during a micro-moment or macro-moment when a person or person need to do or get something, helps make it happen in real time.

27. The process in claim 23, wherein the system enables person (or persons) to act to meet need and achieve a better future.
a. Addresses both near and long term need.
b. Addresses need in context of person's, all others' and our world's needs.
c. Suggests other needs that might be appropriate.
d. Suggests what will help person(s), all others and our world survive and thrive.

28. The process in claim 23, wherein the system motivates person (or persons) to act to meet need and achieve a better future.
a. Addresses both near and long term need.
b. Addresses need in context of person's, all others' and our world's needs.
c. Suggests other needs that might be appropriate.
d. Suggests what will help person(s), all others and our world survive and thrive.

29. The process in claim 23, wherein the system_helps person, persons and the world survive and thrive.

30. The process wherein a person or person can use the Thrive! system to act to meet need and achieve a better future for person(s), all others and our world so that all survive and thrive.

31. The process wherein a person or persons can use the Thrive! system to directly execute action and/or partners with Thrive! system to jointly execute action, and/or uses Thrive! system output to execute action.

32. Thrive! system supports a surviving and thriving future. It supports the aspiration for a future when all thrive forever.

33. The process in claim 32, wherein the system_helps achieve what is wanted and needed to survive and thrive.

34. The process in claim 32, wherein the system_supports the aspiration for a future when all thrive forever.
